(19) United States
(12) Patent Application Publication
(10) Pub. No.: US 2025/0253092 A1
(43) Pub. Date: Aug. 7, 2025

(54) INDUCTOR STRUCTURE AND FORMING METHOD THEREFOR

(71) Applicant: SHANGHAI METAPWR ELECTRONICS CO., LTD, Shanghai (CN)

(72) Inventors: Shouyu HONG, Shanghai (CN); Mingzhun ZHANG, Shanghai (CN); Xiaoni Xin, Shanghai (CN)

(73) Assignee: SHANGHAI METAPWR ELECTRONICS CO., LTD, Shanghai (CN)

(21) Appl. No.: 19/035,988

(22) Filed: Jan. 24, 2025

(30) Foreign Application Priority Data
Feb. 7, 2024 (CN) 202410174510.4

(51) Int. Cl. H01F 27/32; H01F 3/14; H01F 27/29; H01F 27/38; H01F 41/12

(52) U.S. Cl. CPC H01F 27/324; H01F 3/14; H01F 27/29; H01F 27/38; H01F 41/127; H01F 2027/297

(57) ABSTRACT

The application provides an inductor structure. The inductor structure comprises a magnetic core, a first winding unit, a second winding unit and an insulating object/insulating composition, wherein the insulating object/insulating composition is pressed and has little rebound at normal temperature, so that the risk that the magnetic core is broken due to rebound of the insulating material during pressing can be effectively reduced; the resistivity of the insulating object/insulating composition is greater than or equal to 2 Mohm·m; and the melting temperature of the insulating object is smaller than the annealing temperature of the magnetic material. When the insulating object is subjected to high-temperature annealing, the insulating object is in at least part of the melting state, and the micropore structure between the particles of the magnetic core material can effectively buffer the volume expansion when the insulating object is melted.

### CROSS-REFERENCE TO RELATED APPLICATION

This application claims the priority benefit of China application serial no. 202410174510.4, filed on Feb. 7, 2024, 2018. The entirety of the above-mentioned patent application is hereby incorporated by reference herein and made a part of this specification.

### BACKGROUND

### Description of Related Art

In recent years, with the development of technologies such as data centers, artificial intelligence, supercomputers and the like, more and more powerful ASICs are applied, such as CPUs, GPUs, machine learning accelerators, network switches, servers and the like, which consume a large amount of current, for example, the required current can reach thousands of amperes; and the current has the characteristic of rapid jump. A voltage regulator module (VRM, Voltage Regulator Modules, ie, a power converter module according to the present application), comprising a buck circuit (Buck), is conventionally used to supply such a load.

In the prior art, an anti-coupling inductor technology is usually adopted to solve the problem, and the anti-coupling inductor technology has relatively low leakage inductance, so that the anti-coupling inductor technology has relatively high transient response; meanwhile, the anti-coupling inductor has relatively high steady-state equivalent inductance, so that the efficiency is improved; and the anti-coupling inductor technology can meet the requirement of transient performance and improve the efficiency, so that the anti-coupling technology is a technology commonly adopted by a VRM at present. The most important of the anti-coupling inductor technology is the design and manufacturing of the inductor.

An inductor generally comprises at least one winding, a magnetic core and an insulating material, an existing inductor generally adopts an integrally formed inductor of the iron powder core directly pressing winding, and due to the fact that the machining process is simple, high automation and batch manufacturing are easy to use, and the magnetoelectric performance of the iron powder core is poor. In order to obtain the high-performance magnetic element, magnetic materials such as an iron-silicon-aluminum powder core (FeSiAl), an iron-nickel powder core (FeNi), an iron-nickel-manganese powder core (FeNiMo), an iron-silicon powder core (FeSi), an iron-silicon-chromium powder core (FeSiCr) and the like need to be used for obtaining the high-performance magnetic element. However, the high-temperature annealing/sintering process needs to be carried out on the magnetic elements made of the high-performance magnetic materials, the temperature usually needs to be 500° C. or above, and the annealing temperature of the special iron-silicon-aluminum powder core is near 700 degrees. The insulating object in the inductance magnetic core is extremely easy to expand or generate gas in the annealing process, so that the magnetic core is subjected to stress from inside to outside, and when the magnetic core is stressed, the magnetic core is easy to break or crack, so that the inductance is invalid or the reliability is reduced.

Moreover, the annealing/sintering process temperature of the magnetic element is far higher than the temperature resistance value of the organic material. Meanwhile, when the magnetic core and the winding are co-pressed, the pressure is even as high as 10 tons per square centimeter, and is far higher than the compressive strength of the generally inorganic material.

### SUMMARY

In view of the above, one of the objectives of the present application is to provide an inductor structure, comprising:
a magnetic core;
a first winding unit, the first winding unit being at least partially disposed in the magnetic core;
a second winding unit, the second winding unit being at least partially disposed in the magnetic core;
an insulating object disposed between the first winding unit and the second winding unit;
the insulating object is bonded with an adjacent magnetic core or winding unit after annealing, and a resistivity of the insulating object after annealing is greater than or equal to 2 Mohm·m; and a melting temperature of the insulating object is smaller than an annealing temperature.

Preferably, wherein the insulating object comprises low-melting-point glass.

Preferably, wherein the insulating object comprises a low-melting-point glass composition, and the low-melting-point glass composition comprises granular low-melting-point glass particles and an inorganic binder/organic binder.

Preferably, wherein the insulating object is an insulating composition, and the insulating composition includes an insulating object, an insulating interlayer and an insulating object which are sequentially arranged; and the insulating interlayer is a high-temperature-resistant insulating material, and a temperature resistance of the insulating interlayer is higher than the annealing temperature.

Preferably, wherein the insulating object comprises a glass fiber braid comprising warp yarns formed of a plurality of strands of fibers and weft yarns formed of a plurality of strands of fibers.

Preferably, wherein the magnetic core comprises a top surface, a bottom surface, a first side surface and a second side surface, and the first side surface and the second side surface are opposite; an air gap is formed between the first winding unit and the second winding unit, and the insulating object is arranged between the first winding unit and the second winding unit, and the insulating object is arranged in the air gap and used for filling the air gap.

Preferably, wherein the first winding unit comprises a first winding, and the second winding unit comprises a second winding; the first winding and the second winding each comprises a first end and a second end, and pins are arranged at the first and second ends of the first winding and the second winding.

Preferably, wherein the first winding unit further comprises a first auxiliary winding coupled to the first winding; the second winding unit further comprises a second auxiliary winding coupled with the second winding; the first auxiliary winding and the second auxiliary winding both comprise a first end and a second end, and pins are arranged at the first and second ends of the first auxiliary winding and the second auxiliary winding; and an insulating composition is arranged between the first winding and the first auxiliary winding, and an insulating composition is arranged between the second winding and the second auxiliary winding.

Preferably, wherein each insulating composition includes an insulating object, an insulating interlayer and an insulating object which are sequentially arranged; and the insulating interlayer is a high-temperature-resistant insulating material, and a temperature resistance of the insulating interlayer is higher than the annealing temperature.

Preferably, wherein the first winding and the second winding both penetrate through the first side surface and the second side surface.

Preferably, wherein pins of the first ends of the first winding and the second winding extend from the first side surface to the bottom surface; and pins of the second ends of the first winding and the second winding extend from the second side surface to the bottom surface.

Preferably, wherein a pin at a first end of the first winding extends from the first side surface to the bottom surface, and a pin at a second end of the first winding extends from the second side surface to the top surface; a pin at the first end of the second winding extends from the first side surface to the top surface, and a pin at the second end of the second winding extends from the second side surface to the bottom surface.

Preferably, wherein the first winding and the second winding both penetrate through the first side surface and the second side surface;
the pins of the first ends of the first winding and the second winding extend from the first side surface to the bottom surface; pins of the second ends of the first winding and the second winding extend from the second side surface to the bottom surface;
shapes of the first auxiliary winding and the first winding are the same, and shapes of the second auxiliary winding and the second winding are the same.

Preferably, wherein the first winding and the second winding both penetrate through the first side surface and the second side surface;
the pin at the first end of the first winding extends from the first side surface to the bottom surface, and the pin at the second end of the first winding extends from the second side surface to the top surface; the pin at the first end of the second winding extends from the first side surface to the top surface, and the pin at the second end of the second winding extends from the second side surface to the bottom surface;
the first auxiliary winding and the second auxiliary winding both penetrate through the second side surface from the first side surface, and pins at the first ends of the first auxiliary winding and the second auxiliary winding extend from the first side surface to the bottom surface; and pins of the second ends of the first auxiliary winding and the second auxiliary winding extend from the second side surface to the bottom surface.

Preferably, wherein the first winding and the second winding are arc-shaped, the first winding and the second winding are stacked up and down, the first and second ends of the first winding are arranged on the first side surface, and the first and second ends of the second winding are arranged on the first side surface.

Preferably, wherein the insulating object is annular.

Preferably, wherein the pin of the first winding is connected with one pin of the second winding in parallel.

Preferably, wherein the first winding and the second winding are square, the first winding and the second winding are stacked up and down, the first and second ends of the first winding are arranged on the first side surface, and the first and second ends of the second winding are arranged on the first side surface.

Preferably, wherein the insulating object is of a “Π”-shape.

Preferably, a method for forming the inductor structure, comprising steps of:
S1, providing the first winding unit and the second winding unit, and forming at least one blank and the insulating object of the magnetic core;
S2, co-pressing a blank, the first winding unit, the second winding unit, the insulating object and another blank or magnetic powder material to form a combined body;
S3, performing a high-temperature annealing on the combined body;
S4, impregnating an annealed composition into an organic material; and
S5, leading out pins to form an inductor structure.

Compared with the prior art, the application has the following beneficial effects:

According to the inductor structure provided by the application, the insulating object

with almost unchanged volume after annealing is adopted, so that the risk that the magnetic core is broken or the inductance characteristic is reduced due to high-pressure gas generated by thermal expansion or material decomposition or gasification of a common material in the magnetic core annealing process is eliminated.

To make the aforementioned more comprehensible, several embodiments accompanied

with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A to FIG. 1C are schematic diagrams of a first embodiment of the present application;

FIG. 2A to FIG. 2B are schematic diagrams of a second embodiment of the present application;

FIG. 3A to FIG. 3B are schematic diagrams of a third embodiment of the present application;

FIG. 4A to FIG. 4B are schematic diagrams of a fourth embodiment of the present application;

FIG. 5A to FIG. 5B are schematic diagrams of a fifth embodiment of the present application;

FIG. 6A to FIG. 6B are schematic diagrams of a sixth embodiment of the present application;

FIG. 7A to FIG. 7B are schematic diagrams of a seventh embodiment of the present application;

FIG. 8 is a schematic diagram of eighth embodiment of the present application.

### DESCRIPTION OF THE EMBODIMENTS

The technical solutions in the embodiments of the present disclosure will be clearly and completely described below with reference to the accompanying drawings in the embodiments of the present disclosure. All other embodiments obtained by a person of ordinary skill in the art based on the embodiments of the present application without creative efforts shall fall within the protection scope of the present application.

### Embodiment 1

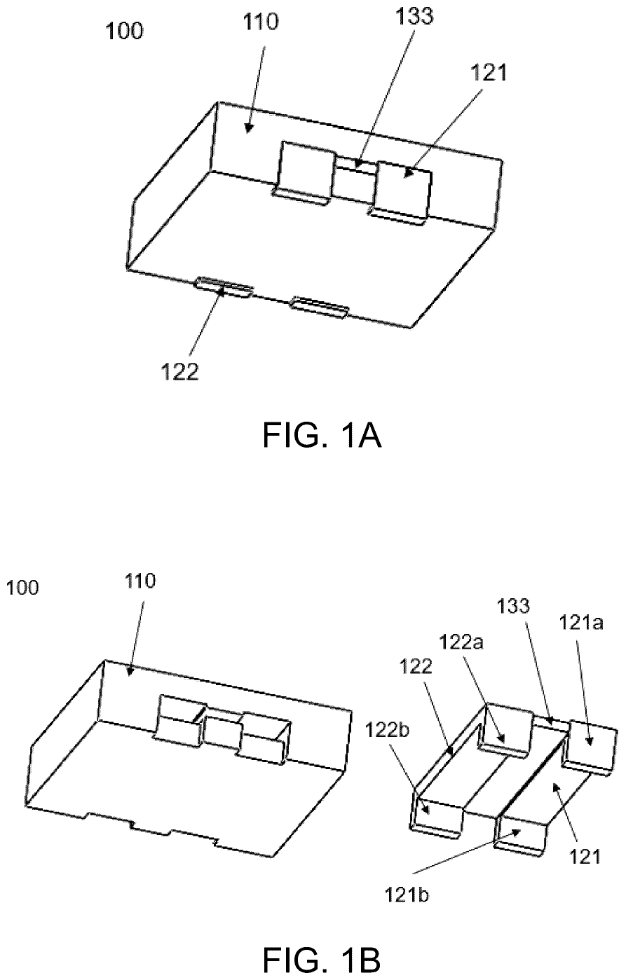

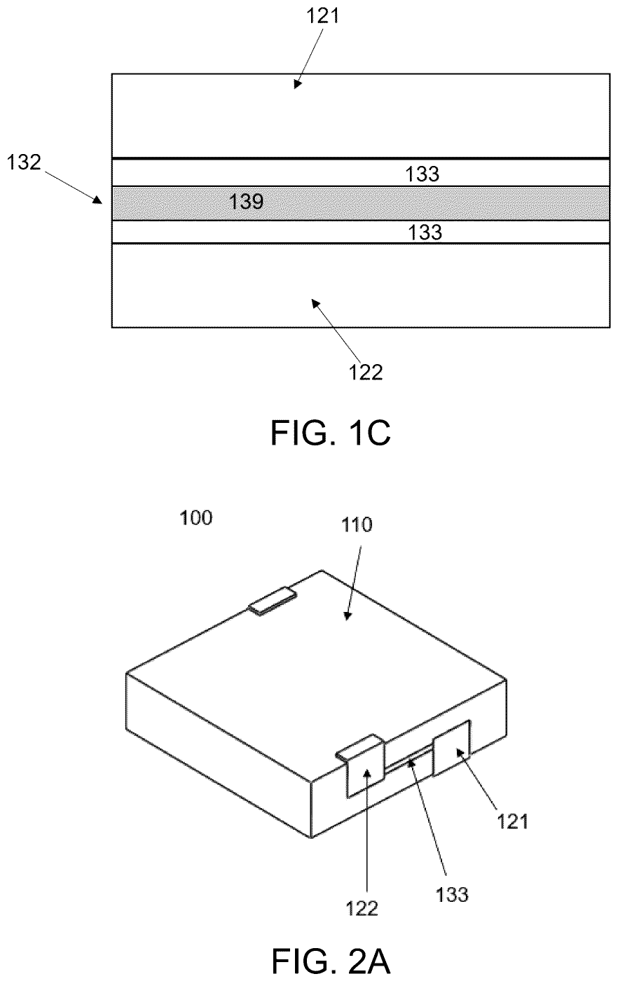

FIG. 1A to FIG. 1B are schematic structural diagrams of an inductor structure. As shown in FIGS. 1A-1B, the inductor structure 100 includes a magnetic core 110, a first winding unit, a second winding unit, and an insulating object 133. The inductor structure 100 or the magnetic core 110 includes a top surface, a bottom surface, a first side surface, and a second side surface opposite to the first side surface. Optionally, the inductor structure 100 is a cuboid, and the inductor structure may also be other cubes. In the embodiment, the first winding unit is parallel to the second winding unit; and the main body of the first winding unit and the main body of the second winding unit are located on the same plane; the first winding unit is a first winding 121, the second winding unit is a second winding 122. The first winding 121 is at least partially arranged in the magnetic core 110, and the second winding 122 is also at least partially arranged in the magnetic core 110; the first winding comprises a first end and a second end, the second winding comprises a first end and a second end; a pin 121a is arranged at the first end of the first winding, a pin 121b is arranged at the second end of the first winding, a pin 122a is arranged at the first end of the second winding, and a pin 122b is arranged at the second end of the second winding.

The first winding 121 and the second winding 122 both penetrate through the first side surface and the second side surface; pins of the first ends of the first winding and the second winding extend from the first side surface to the bottom surface, and pins of the second ends of the first winding and the second winding extend from the second side surface to the bottom surface. The first winding and the second winding are both “[”-shaped sheet-shaped bodies, the main bodies of the first winding and the second winding are sheet-shaped, and the sheet-shaped bodies are parallel to the bottom surface. The first winding and the second winding are parallel.

An air gap is formed between the first winding 121 and the second winding 122, and the insulating object 133 is arranged in the air gap and is used for filling the air gap. The insulating object is bonded to adjacent magnetic cores or windings 121, 122 after annealing, and the resistivity after annealing is greater than or equal to 2 Mohm?m, and the melting temperature of the insulating object is less than the annealing temperature. The insulating object is a pressed non-rebound material, and the coefficient of thermal expansion is smaller than 15×10-6/° C.

Optionally, the insulating object is sheet-shaped; and further optionally, the insulating object is in a rectangular sheet shape, and the sheet-shaped sheet is parallel to the bottom surface. The insulating object extends from the first side surface to the second side surface, the insulating object 133 is disposed between the bodies of the first winding and the body of the second winding, and completely fills the air gap between the first winding and the second winding.

As an embodiment, the insulating object 133 is a fiber, and the compressive strength of the fiber is greater than or equal to 1.5 GPa at normal temperature; and the tensile strength of the fiber along the extension direction of the fiber on the plane of the fiber is greater than or equal to 20 MPa. More preferably, the insulating object 133 is only comprising fibers. Preferably, the fiber fabric is a fiber braided fabric which comprises warp yarns formed by a plurality of strands of fibers and weft yarns formed by a plurality of strands of fibers, and the fibers are at least one of glass fibers and ceramic fibers. More preferably, the fiber is a fiber braided fabric formed of glass fibers. The insulating object 133 is a fiber and has the characteristics of small thermal expansion coefficient and no rebound under pressure. At normal temperature, when the magnetic core, the winding and the fiber are integrally co-formed, the fiber has a certain physical shape, stability and strength; at the annealing temperature of the magnetic core, at least part of the fiber is in a melted state, and the micropore structure between the particles of the magnetic core material can effectively buffer a small volume of expansion when the fiber is melted, so that in the sintering process, the stress generated by the insulating object on the magnetic core is extremely low. The melted insulating object 133 is bonded with the adjacent magnetic core or winding after being cooled and solidified, so that the magnetic core, the winding and the insulating object become a whole, and the strength of the inductor structure is greatly improved. Due to the fact that the tiny gaps between the magnetic core material particles adjacent to the insulating object are at least partially filled with the insulating material, the bonding strength is good. In order to increase the adhesion between the insulating object 133 and the windings 121 and 122, the surfaces of the windings 121 and 122 can be pre-treated, for example, when copper is used as the windings 121 and 122, the copper surface can be oxidized. Therefore, the use of the insulating object 133 can effectively avoid the potential risk that the magnetic core is cracked, the inductance characteristic and the reliability are degraded in the process of pressing, annealing and using the inductor. Moreover, the glass fiber material is free of additional chemical substances after high-temperature annealing and cooling, the size of the glass fiber material does not change, or only tiny changes occur, and stress is hardly generated on the magnetic core; therefore, in the magnetic core annealing process, high-pressure gas generated by thermal expansion or material decomposition or gasification of a common material is eliminated, and the risk that the magnetic core is broken or the inductance characteristic is reduced is reduced.

In a second embodiment, the insulating object 133 is low-melting-point glass. the low-melting-point glass block is pressed without rebound at normal temperature, and the thermal expansion coefficient of the low-melting-point glass at a high temperature is small; the low-melting-point glass is free of gas volatilization in a molten state, and the melted low-melting-point glass and the magnetic core material are easy to form a bonding structure; and in addition, the low-melting-point glass can be matched with the thermal expansion coefficient of the magnetic core material, the shrinkage rate during curing is small, the internal stress of the magnetic core is eliminated, and the magnetic core is prevented from cracking.

As a third embodiment, the insulating object 133 is a low-melting-point glass composition, the low-melting-point glass composition comprises granular low-melting-point glass particles and an inorganic binder, and the low-melting-point glass particles and the inorganic binder are mixed according to a certain proportion, and an insulating object 133 in a required shape is formed in an integrated pressing mode; preferably, the inorganic binder and the inorganic binder in the magnetic material of the magnetic core belong to the same material system. The insulating object 133 obtained in this way has certain fluidity between internal particles, and when the inductor is pressed and formed, the fluidity between particles in the insulating object absorbs a certain pressure, so that the stress between the insulating object and the magnetic material is eliminated, and cracks caused by stress generated by rebound of the insulating object when the inductor is formed are not happened. During annealing and cooling, the expansion coefficient of the low-melting-point glass is small, and the inorganic binder and the inorganic binder in the magnetic material are the same material system, so that the material compatibility is good, and the magnetic core does not crack.

As a fourth embodiment, the insulating object 133 is another low-melting-point glass composition, the low-melting-point glass composition comprises granular low-melting-point glass particles and an organic binder, and the low-melting-point glass particles and the organic binder are mixed according to a certain proportion, and an insulating object 133 in a required shape is formed in an integrated pressing mode; preferably, the volume percentage of the organic binder is lower than 3%. Preferably, the cracking temperature of the organic binder is lower than the melting temperature of the low-melting-point glass. The insulating object obtained in the mode has certain fluidity between internal particles, and when the inductor is pressed and formed, the fluidity between particles in the insulating object absorbs certain pressure, so that the stress between the insulating composition and the magnetic material of the magnetic core is eliminated, and cracks caused by stress generated by rebound of the insulating composition when the inductor is formed are not happened. During annealing, due to the fact that a gap exists between the magnetic core powder particles, the small number of organic binders are fully cracked in the heating stage, and the generated gas is fully released through the gap between the magnetic core powder particles, so that the magnetic core is not seriously influenced. During cooling, the coefficient of expansion of the low-melting-point glass is small, the matching performance with the magnetic core is good, and the integrity of the magnetic core can be ensured.

As a fifth embodiment, the insulating object 133 is a pressed object with the low-melting-point glass, which is directly pressed into a blank from granular low-melting-point glass particles.

As a sixth implementation mode, as shown in FIG. 1C, the insulating composition 132 is used for replacing the insulating object 133 and is arranged in the air gap, the insulating composition 132 comprises an insulating object 133, an insulating interlayer 139 and an insulating object 133 which are sequentially arranged, the insulating interlayer 139 is a high-heat-resistance insulating material, the temperature resistance of the insulating interlayer 139 is higher than the annealing temperature of the magnetic core, for example, the high-heat-resistance insulating material is at least one of a ceramic sheet and a high-melting-point glass fiber cloth. Optionally, the insulating object 133 in the insulating composition 132 is any one of the insulating objects 133 in the first to fifth embodiments, preferably, the insulating object 133 in the insulating composition 132 is low-melting-point glass. The insulating interlayer 139 and the insulating object 133 can be directly compounded, and can also be formed by bonding a small amount of inorganic/organic binder. Due to the fact that the low-melting-point glass is easy to form a bonding structure after melting, the magnetic core can be well prevented from cracking, and tiny cracks possibly generated in the pressing process of the high-heat-resistance insulating material can be repaired. Furthermore, the insulating interlayer 139 can be used as a carrier plate for arranging the insulating object 133, so that the manufacturability is improved. For example, a slurry containing an insulating material can be arranged on the surface of the insulating interlayer 139 (in addition to the insulating material, auxiliary components such as a solvent, a dispersing agent and a binder can also be contained), and a semi-finished product of the insulating composition 132 is formed through processes such as certain drying, high-temperature glue discharging and the like. After drying and high-temperature glue discharging, high-temperature sintering can be added, so that the insulating object 133 is in a partially sintered or completely sintered state. The sintering degree of the insulating material can influence the melting temperature of the insulating object 133, so that the sintering degree can be set according to needs, but the melting temperature after sintering should be lower than the annealing temperature of the magnetic core. Furthermore, optionally, the insulating interlayer 139 is a high-thermal-conductivity material, and the thermal conductivity of the insulating interlayer 139 is greater than 10 W/moK, so that the heat transfer performance of the inductor can be further improved.

It should be noted that one end of the insulating material 133 is exposed to the first side surface and/or the second side surface, and a stress release port is provided. The stress level of the magnetic core in the link of pressing, sintering, cooling and the like in the inductor forming process can be further reduced.

### Embodiment 2

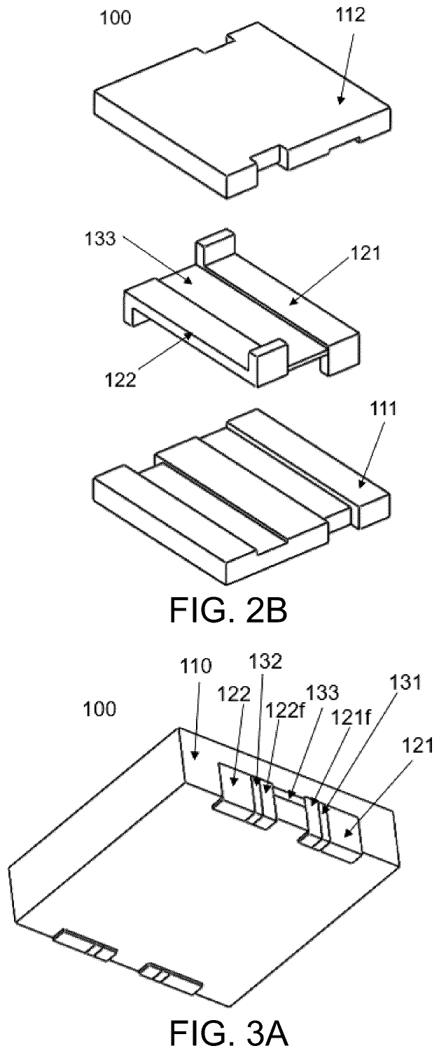

FIG. 2A is a schematic structural diagram of an inductor structure 100 according to an embodiment, and FIG. 2B is an exploded view of FIG. 2A. As shown in FIG. 2A and FIG. 2B, the difference between the embodiment and the first embodiment is that the arrangement of the first winding 121 and the second winding 122 is different. In the embodiment, the pin 121a at the first end of the first winding 121 extends from the first side surface to the bottom surface, and the pin 121b at the second end of the first winding extends from the second side surface to the top surface; the pin 122a at the first end of the second winding 122 extends from the first side surface to the top surface, and the pin 122b at the second end of the second winding 122 extends from the second side surface to the bottom surface. The winding of the embodiment expands the application range of the coupling inductor.

### Embodiment 3

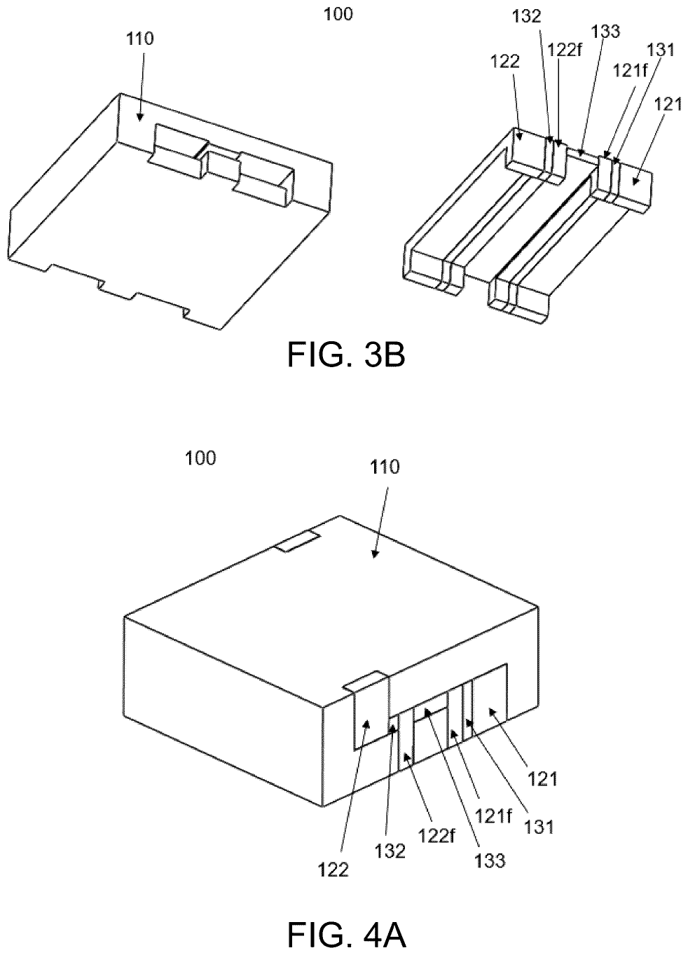

FIG. 3A is a schematic structural diagram of an inductor structure 100 according to an embodiment, and FIG. 3B is an exploded view of FIG. 3A. As shown in FIGS. 3A-3B, the embodiment has the same technical effect as the first embodiment, and the difference between the embodiment and the first embodiment lies in that the arrangement of the first winding unit and the second winding unit is different from that of the embodiment. In the embodiment, the first winding unit and the second winding unit are parallel, and the first winding unit comprises a first winding 121 and a first auxiliary winding 121f coupled with the first winding 121; and the second winding unit includes a second winding 122 and a second auxiliary winding 122f coupled to the second winding 122; the first auxiliary winding 121f and the second auxiliary winding 122f both comprise a first end and a second end, and pins are arranged at the two ends of the first auxiliary winding and the second auxiliary winding; an insulating composition 132 is arranged between the first winding 121 and the first auxiliary winding 121f, and an insulating composition 132 is arranged between the second winding 122 and the second auxiliary winding 122f. An air gap between the first winding unit and the second winding unit can be filled with an insulating object 133, or can be filled with an insulating composition 132. The two auxiliary windings are adjacent to each other, the two windings are away from each other, that is, the first auxiliary winding and the second auxiliary winding are arranged close to each other, and the first winding and the second winding are away from each other.

The first winding 121 and the second winding 122 both penetrate through the first side surface and the second side surface; pins of the first ends of the first winding 121 and the second winding 122 extend from the first side surface to the bottom surface; pins of the second ends of the first winding 121 and the second winding 122 extend from the second side surface to the bottom surface; the first auxiliary winding 121f and the first winding 121 are the same in shape, the second auxiliary winding 122f and the second winding 122 are the same in shape, the auxiliary winding and the winding are arranged in parallel, and the width of the auxiliary winding is narrower than the width of the winding.

### Embodiment 4

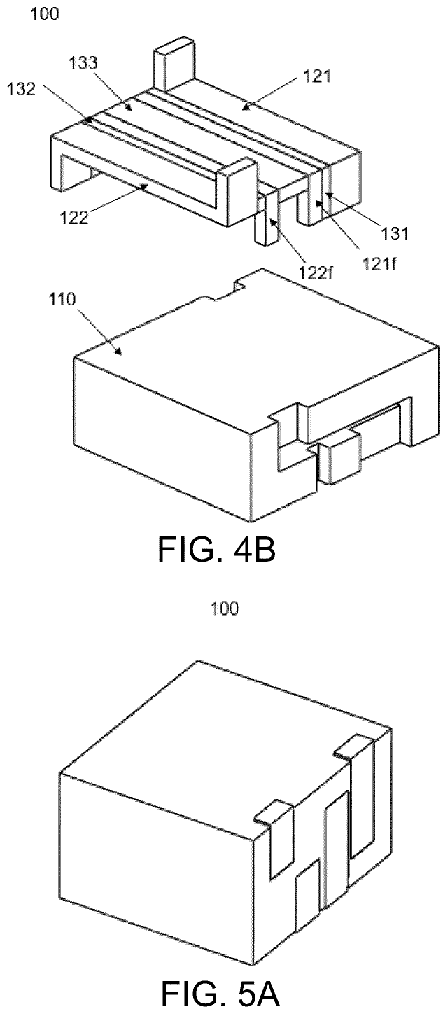

FIG. 4A is a schematic structural diagram of an inductor structure 100 of the present embodiment, and FIG. 4B is an exploded view of FIG. 4A. As shown in FIGS. 4A-4B, the embodiment has the same technical effect as Embodiment 3, and the difference between the embodiment and Embodiment 3 lies in that the arrangement of the first winding 121 and the second winding 122 is different. In the present embodiment, the first winding 121 and the second winding 122 both penetrate through the first side surface and the second side surface, the pin at the first end of the first winding 121 extends from the first side surface to the bottom surface, and the pin at the second end of the first winding 121 extends from the second side surface to the top surface; the pin at the first end of the second winding 122 extends from the first side surface to the top surface, and the pin at the second end of the second winding 122 extends from the second side surface to the bottom surface.

### Embodiment 5

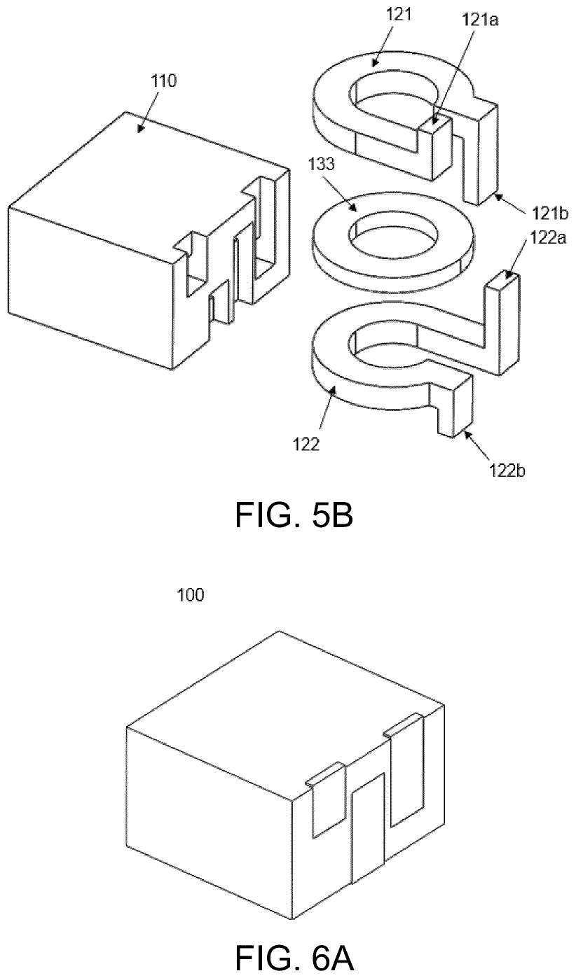

FIG. 5A is a schematic structural diagram of an inductor structure 100 according to an embodiment, and FIG. 5B is an exploded view of FIG. 5A. As shown in FIGS. 5A-5B, the embodiment has the same technical effect as Embodiment 1, and the difference between the embodiment and Embodiment 1 lies in that the arrangement of the first winding 121 and the second winding 122 is different. In the embodiment, the first winding 121 and the second winding 122 are arc-shaped, and the first winding and the second winding are stacked up and down, that is, the main body of the first winding 121 and the main body of the second winding 122 are not on the same plane; pins at the two ends of the first winding 121 are arranged on the first side surface, and pins at the two ends of the second winding are both arranged on the first side surface. The insulating object 133 is in a circular ring shape, and the insulating object 133 is arranged between the first winding 121 and the second winding 122 and is used for filling an air gap, and the projections of the insulating object 133, the main body of the first winding and the main body of the second winding on the same plane are at least partially overlapped; and preferably, the projections are perfectly overlapped. The arrangement has the advantages that the overlapping length of the windings is longer, and the coupling coefficient between the two windings is higher. It should be noted that pins at two ends of the first winding 121 are disposed on the first side surface, and pins at two ends of the second winding 122 are disposed on the second side surface.

### Embodiment 6

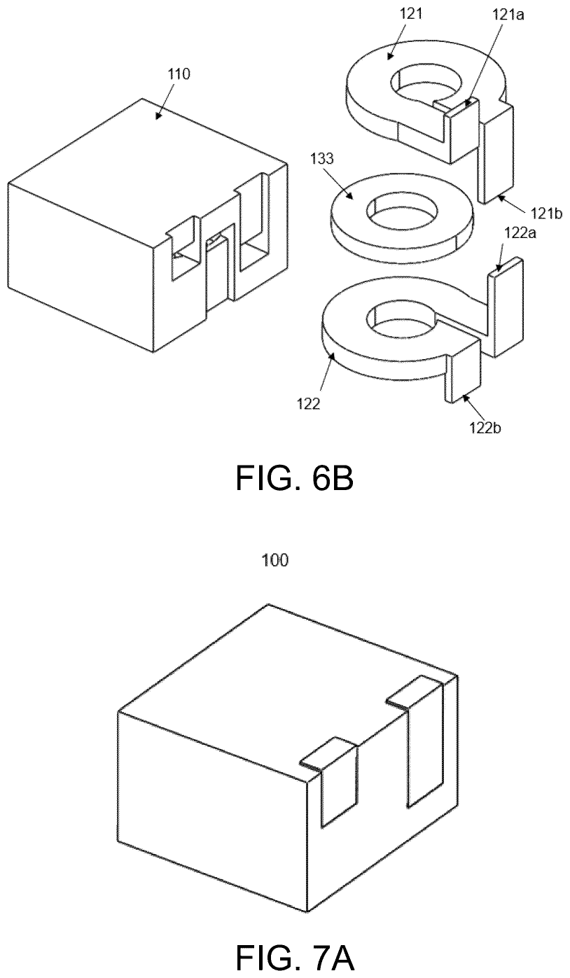

FIG. 6A is a schematic structural diagram of an inductor structure 100 according to an embodiment, and FIG. 6B is an exploded view of FIG. 6A. As shown in FIGS. 6A-6B, the embodiment and the fifth embodiment have the same technical effect, and the difference between the embodiment and the fifth embodiment lies in that one pin of the first winding 121 is in parallel connection with one pin of the second winding 122 in parallel. The arrangement has the advantages that the direct-current impedance of the two windings is lower, and the efficiency is improved.

### Embodiment 7

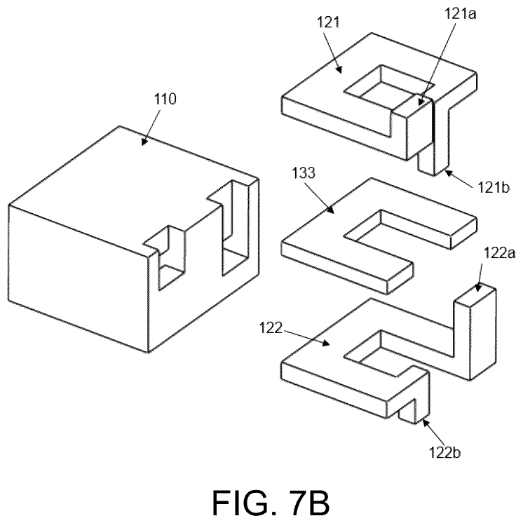

FIG. 7A is a schematic structural diagram of an inductor structure 100 according to an embodiment, and FIG. 7B is an exploded view of FIG. 7A. As shown in FIGS. 7A-7B, the embodiment and the fifth embodiment have the same technical effect, and the difference between the embodiment and the fifth embodiment lies in that the arrangement of the first winding 121 and the second winding 122 is different. In the embodiment, the first winding 121 and the second winding 122 are square, and the first winding 121 and the second winding 122 are stacked up and down, that is, the main body of the first winding 121 and the main body of the second winding 122 are not on the same plane; the two ends of the first winding 121 are arranged on the first side surface, and the two ends of the second winding 122 are arranged on the first side surface. The insulating object is of a “Π”-shape. The insulating object 133 is disposed between the first winding 121 and the second winding 122 for filling an air gap; projections of the insulating object 133, the main body of the first winding and the main body of the second winding on the same plane are at least partially overlapped; and preferably, the projections are perfectly overlapped. The arrangement has the advantages that the overlapping length of the windings is longer, and the coupling coefficient between the two windings is higher. Meanwhile, the two windings are square, the winding is simpler to manufacture, the manufacturing efficiency is higher, and the cost is lower.

### Embodiment 8

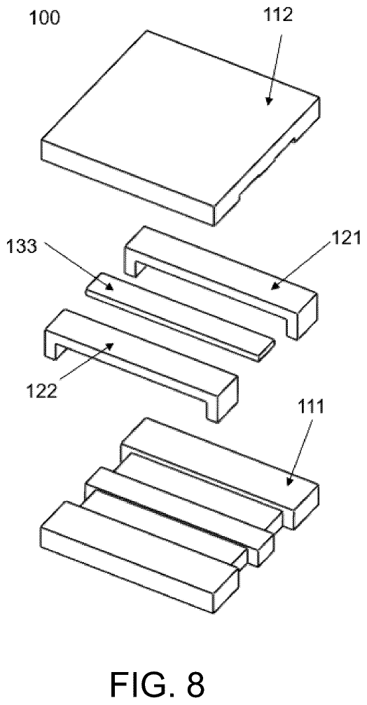

FIG. 8 is a schematic diagram of a manufacturing method of an inductor structure 100 according to an embodiment. As shown in FIG. 8, the application provides a forming method of an inductor structure:
S1, providing a first winding unit and a second winding unit, and forming at least one blank 111, 112 and an insulating object 133 of the magnetic core 110;
S2, co-pressing a blank 112, a first winding unit, a second winding unit, an insulating object 133 and another blank 111 or a magnetic powder material to form a combined body;
S3, performing high-temperature annealing on the combination body;
S4, impregnating the annealed composition into an organic material;
S5, leading out pins to form an inductor structure 100.

In the step S1, the first winding unit may be a first winding or a first winding and a first auxiliary winding, and the second winding unit may be a second winding or a second winding and a second auxiliary winding. The insulating object 133 may also be an insulating composition 132 in which the first winding unit, the second winding unit, and the insulating object 133 each form a desired shape.

### Embodiment 9

The difference between the embodiment and the eighth embodiment lies in that the slurry containing the insulating object 133 can be arranged on the blank 111 and/or 112 (in addition to the insulating object 133, also comprises auxiliary components such as a solvent, a dispersing agent and a binder), and through drying and high-temperature glue discharging, even through high-temperature sintering, so that the insulating object 133 is in a partially sintered or completely sintered state. However, all the pre-treatment temperatures and the melting temperature after the insulation object 133 is sintered should be lower than the annealing temperature of the magnetic core. In this way, the production efficiency can be further improved.

### Embodiment 10

The difference between the embodiment and the eighth embodiment lies in that the first winding unit, the second winding unit and the insulating object 133 can be pre-combined (bonded and sintered) into a combination.

The method in the eighth to tenth embodiments can be applied to manufacturing any one of the inductor structures in the first embodiment to the seventh embodiment.

The “equal” or “same” or “equal to” disclosed by the application needs to consider the parameter distribution of engineering, and the error distribution is within +/−30%; and the included angle between the two line segments or the two straight lines is less than or equal to 45 degrees; the included angle between the two line segments or the two straight lines is within the range of [60, 120]; and the definition of the phase error phase also needs to consider the parameter distribution of the engineering, and the error distribution of the phase error degree is within +/−30%. In addition, relational terms such as first and second are used herein to distinguish one entity or operation from another entity or operation, and do not necessarily require or imply that there is any such actual relationship or sequence between these entities or operations. Moreover, the terms “comprising,” “including,” or any other variation thereof are intended to cover a non-exclusive inclusion, such that a process, method, article, or device that includes a series of elements includes not only those elements, but also other elements that are not explicitly listed, or elements inherent to such a process, method, article, or device. In the absence of more restrictions, a statement “comprising one. A defined element does not preclude the existence of additional identical elements in the process, method, article, or device that includes the element.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An inductor structure, comprising:
a magnetic core;
a first winding unit, the first winding unit being at least partially disposed in the magnetic core;
a second winding unit, the second winding unit being at least partially disposed in the magnetic core;
an insulating object disposed between the first winding unit and the second winding unit;
the insulating object is bonded with an adjacent magnetic core or winding unit after annealing, and a resistivity of the insulating object after annealing is greater than or equal to 2 Mohm·m; and a melting temperature of the insulating object is smaller than an annealing temperature.

2. The inductor structure of claim 1, wherein the insulating object comprises low-melting-point glass.

3. The inductor structure of claim 2, wherein the insulating object comprises a low-melting-point glass composition, and the low-melting-point glass composition comprises granular low-melting-point glass particles and an inorganic binder/organic binder.

4. The inductor structure of claim 1, wherein the insulating object is an insulating composition, and the insulating composition includes an insulating object, an insulating interlayer and an insulating object which are sequentially arranged; and the insulating interlayer is a high-temperature-resistant insulating material, and a temperature resistance of the insulating interlayer is higher than the annealing temperature.

5. The inductor structure of claim 1, wherein the insulating object comprises a glass fiber braid comprising warp yarns formed of a plurality of strands of fibers and weft yarns formed of a plurality of strands of fibers.

6. The inductor structure of claim 1, wherein the magnetic core comprises a top surface, a bottom surface, a first side surface and a second side surface, and the first side surface and the second side surface are opposite; an air gap is formed between the first winding unit and the second winding unit, and the insulating object is arranged between the first winding unit and the second winding unit, and the insulating object is arranged in the air gap and used for filling the air gap.

7. The inductor structure of claim 6, wherein the first winding unit comprises a first winding, and the second winding unit comprises a second winding; the first winding and the second winding each comprises a first end and a second end, and pins are arranged at the first and second ends of the first winding and the second winding.

8. The inductor structure of claim 7, wherein the first winding unit further comprises a first auxiliary winding coupled to the first winding; the second winding unit further comprises a second auxiliary winding coupled with the second winding; the first auxiliary winding and the second auxiliary winding both comprise a first end and a second end, and pins are arranged at the first and second ends of the first auxiliary winding and the second auxiliary winding; and an insulating composition is arranged between the first winding and the first auxiliary winding, and an insulating composition is arranged between the second winding and the second auxiliary winding.

9. The inductor structure of claim 8, wherein each insulating composition includes an insulating object, an insulating interlayer and an insulating object which are sequentially arranged; and the insulating interlayer is a high-temperature-resistant insulating material, and a temperature resistance of the insulating interlayer is higher than the annealing temperature.

10. The inductor structure of claim 7, wherein the first winding and the second winding both penetrate through the first side surface and the second side surface.

11. The inductor structure of claim 10, wherein pins of the first ends of the first winding and the second winding extend from the first side surface to the bottom surface; and pins of the second ends of the first winding and the second winding extend from the second side surface to the bottom surface.

12. The inductor structure of claim 10, wherein a pin at a first end of the first winding extends from the first side surface to the bottom surface, and a pin at a second end of the first winding extends from the second side surface to the top surface; a pin at the first end of the second winding extends from the first side surface to the top surface, and a pin at the second end of the second winding extends from the second side surface to the bottom surface.

13. The inductor structure of claim 8, wherein the first winding and the second winding both penetrate through the first side surface and the second side surface;
the pins of the first ends of the first winding and the second winding extend from the first side surface to the bottom surface; pins of the second ends of the first winding and the second winding extend from the second side surface to the bottom surface;
shapes of the first auxiliary winding and the first winding are the same, and shapes of the second auxiliary winding and the second winding are the same.

14. The inductor structure of claim 8, wherein the first winding and the second winding both penetrate through the first side surface and the second side surface;
the pin at the first end of the first winding extends from the first side surface to the bottom surface, and the pin at the second end of the first winding extends from the second side surface to the top surface; the pin at the first end of the second winding extends from the first side surface to the top surface, and the pin at the second end of the second winding extends from the second side surface to the bottom surface;
the first auxiliary winding and the second auxiliary winding both penetrate through the second side surface from the first side surface, and pins at the first ends of the first auxiliary winding and the second auxiliary winding extend from the first side surface to the bottom surface; and pins of the second ends of the first auxiliary winding and the second auxiliary winding extend from the second side surface to the bottom surface.

15. The inductor structure of claim 7, wherein the first winding and the second winding are arc-shaped, the first winding and the second winding are stacked up and down, the first and second ends of the first winding are arranged on the first side surface, and the first and second ends of the second winding are arranged on the first side surface.

16. The inductor structure of claim 15, wherein the insulating object is annular.

17. The inductor structure of claim 16, wherein the pin of the first winding is connected with one pin of the second winding in parallel.

18. The inductor structure of claim 7, wherein the first winding and the second winding are square, the first winding and the second winding are stacked up and down, the first and second ends of the first winding are arranged on the first side surface, and the first and second ends of the second winding are arranged on the first side surface.

19. The inductor structure of claim 18, wherein the insulating object is of a “Π”-shape.

20. A method for forming the inductor structure according to claim 1, comprising steps of:
S1, providing the first winding unit and the second winding unit, and forming at least one blank and the insulating object of the magnetic core;
S2, co-pressing a blank, the first winding unit, the second winding unit, the insulating object and another blank or magnetic powder material to form a combined body;
S3, performing a high-temperature annealing on the combined body;
S4, impregnating an annealed composition into an organic material; and
S5, leading out pins to form an inductor structure.
